(19) United States
(12) Patent Application Publication
(10) Pub. No.: US 2025/0307986 A1
(43) Pub. Date: Oct. 2, 2025

(54) VECTORIZING DIGITAL IMAGES WITH SUB-PIXEL ACCURACY USING DYNAMIC UPSCALING

(71) Applicant: Adobe Inc., San Jose, CA (US)

(72) Inventors: Keerti Harpavat, Udaipur (IN); Souymodip Chakraborty, Bangalore (IN); Michael Gharbi, San Francisco, CA (US); Matthew Fisher, San Francisco, CA (US); Jaswant Singh Ranawat, Chittorgarh (IN); Ankit Phogat, Noida (IN); Vineet Batra, Pitam Pura (IN)

(21) Appl. No.: 18/619,610

(22) Filed: Mar. 28, 2024

(51) Int. Cl. G06T 3/4053; G06T 5/70; G06T 7/11; G06T 7/13; G06T 11/60; G06V 10/56

(52) U.S. Cl. CPC G06T 3/4053; G06T 5/70; G06T 7/11; G06T 7/13; G06T 11/60; G06V 10/56

(57) ABSTRACT

The present disclosure relates to systems, methods, and non-transitory computer-readable media that selectively utilizes an image super-resolution model to upscale image patches corresponding to high frequency portions. In particular, the disclosed systems select a set of image patches corresponding to high frequency portions of a digital image at a first resolution. Furthermore, the disclosed systems utilize an image super-resolution model to generate upscaled image patches for the set of image patches of the high-frequency portions to a second resolution higher than the first resolution according to an upscaling factor of at least two. The disclosed systems generate a segmentation map of the digital image based on the upscaled image patches and an upscaled segmentation corresponding to low-frequency portions of the digital image. Further, the disclosed systems generate a vectorized digital image for the digital image according to the segmentation map.

### BACKGROUND

Recent years have seen significant advancement in hardware and software platforms for processing digital images for use in many different digital and print scenarios. For example, many software platforms use vectorization models to convert raster images into vector images because of the lossless scaling advantages of vector images. Many of these vectorization models provide tools that allow client devices to convert complicated raster images to vector images at a high level of quality while preserving many of the complex elements from the raster images. Despite these advancements, existing software platform systems continue to suffer from a variety of problems with regard to computational efficiency, accuracy of the resulting vector images, and image processing flexibility of computing devices implementing vectorization models.

### SUMMARY

One or more embodiments described herein provide benefits and/or solve one or more of the problems in the art with systems, methods, and non-transitory computer-readable media that vectorizes a digital image by selectively upscaling high-frequency image patches using an image super-resolution model. Specifically, the disclosed system identifies high-frequency regions in a digital image using edge detection and upscales those regions using the image super-resolution model. Additionally, the disclosed system upscales a segmentation of low-frequency regions of the digital image according to an upscaling factor. Moreover, the disclosed system combines the upscaled set of image patches for the high-frequency regions and the upscaled segmentation for the low-frequency regions to generate a segmentation map (e.g., as part of a vectorization pipeline). Accordingly, in some embodiments, the disclosed system generates a vectorized digital image according to the generated segmentation map.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an example environment in which a selective super-resolution system operates in accordance with one or more implementations;

FIG. 2 illustrates an overview of the selective super-resolution system selecting a set of image patches for high-frequency portions and applying an image super-resolution model to the selected set of image patches in accordance with one or more implementations;

FIG. 3 illustrates an example diagram of the selective super-resolution system using an edge detection model to select image patches for high-frequency portions of a digital image in accordance with one or more implementations;

FIG. 4 illustrates an example diagram of the selective super-resolution system using an image super-resolution model for high-frequency image patches and an upscaling factor for upscaling a segmentation of low-frequency image patches in accordance with one or more implementations;

FIG. 5 illustrates an example diagrams of the selective super-resolution system combining a segmentation of the upscaled image patches with the upscaled segmentation of the low frequency portions to generate a segmentation map in accordance with one or more implementations;

FIG. 6 illustrates an example diagram of the selective super-resolution system generating image pairs for augmenting a training dataset in accordance with one or more implementations;

FIG. 7 illustrates an example diagram of the selective super-resolution system adjusting parameters of the image super-resolution model in accordance with one or more implementations;

FIG. 8 illustrates a schematic diagram of the selective super-resolution system in accordance with one or more implementations;

FIG. 9 illustrates a flowchart of a series of acts for generating a vectorized digital image according to a segmentation map in accordance with one or more implementations;

FIG. 10 illustrates a block diagram of an exemplary computing device in accordance with one or more implementations.

### DETAILED DESCRIPTION

One or more embodiments described herein include a selective super-resolution system that vectorizes raster images via selective processing of portions of a raster image using an image super-resolution model for efficient downstream sub-pixel vectorization. Specifically, the selective super-resolution system identifies high-frequency portions of the raster image (e.g., using edge detection) and processes only image patches that include the high-frequency portions via the image super-resolution model. Additionally, the selective super-resolution system combines a segmentation of the upscaled high-frequency image patches (e.g., upscaled utilizing the image super-resolution model, by a factor of at least two) with an upscaled segmentation of the low-frequency image patches (e.g., where the segmentation of the low-frequency patches are upscaled according to an upscaling factor) to generate a segmentation map. The selective super-resolution system uses the segmentation map for vectorizing the raster image. Additionally, in some embodiments, the selective super-resolution system trains the image super-resolution model using an augmented training dataset, such as by generating modified versions of aliased and anti-aliased pairs of a rasterized version of a vector image.

As mentioned above, the selective super-resolution system identifies high-frequency portions of the image using edge detection. In some embodiments, the selective super-resolution system utilizes an edge detection model to generate an edge map from the digital image. Additionally, from the edge map, the selective super-resolution system selects (e.g., by minimizing) a number of image patches including high-frequency image data of the raster image.

As also mentioned, the selective super-resolution system combines the segmentation of the upscaled high-frequency portions with the upscaled segmentation of the low-frequency portions. In other words, the selective super-resolution system selectively employs the image super-resolution model to upscale only the high-frequency portions. Specifically, the selective super-resolution system upscales a segmentation of the low-frequency portions according to an upscaling factor and combines the upscaled low-frequency segmentation with a segmentation (generated utilizing a segmentation model) of the upscaled image patches. Moreover, in some embodiments, the selective super-resolution system generates the vectorized digital image according to the segmentation map by utilizing the segmentation map to perform additional vectorization tasks (e.g., curve tracing).

As mentioned above, in some embodiments, the selective super-resolution system trains the image super-resolution model using an augmented dataset. Specifically, the selective super-resolution system accesses a vectorized image dataset and rasterizes vector images to create image pairs that includes raster images with aliasing and with anti-aliasing. Moreover, in some instances, the selective super-resolution system further augments the aliased/anti-aliased versions of the raster images to create additional image pairs with additional augmentations. Utilizing the various image pairs, the selective super-resolution system adjusts (e.g., optimizes) parameters of the image super-resolution model to reduce the output of a loss function based on differences between images in the image pairs.

As mentioned above, many conventional systems suffer from a number of issues in relation to efficiency, accuracy, and operational flexibility in connection with vectorizing raster images. Specifically, conventional systems suffer from computational inefficiencies in increasing the resolution of a digital image via super resolution models. For example, conventional systems apply super resolution to an entire digital image, which incurs large computational costs. In addition to the large computational costs of applying super resolution to an entire digital image, conventional systems also suffer from inefficiencies of increasing the resolution of images on mobile devices or other devices that have limited computing resources. Specifically, mobile devices typically lack sufficient GPU/CPU (e.g., graphics processing unit/central processing unit) resources to compute the super resolution of an entire digital image without long processing times or without accessing remote computing resources to perform the super resolution operations.

Furthermore, in some embodiments, conventional systems further suffer from computational inaccuracies. Specifically, conventional systems typically struggle with domain gaps, where conventional super-resolution models are mostly trained on natural images. For example, because conventional systems (e.g., conventional systems that utilize a vectorization algorithm with super resolution as a sub-part) utilize models trained primarily on natural images, conventional systems struggle with accurately performing image vectorization. For instance, using natural images for training conventional models poses issues with drastically different image spaces and results in inaccurate vectorization of raster images.

Related to the computational inefficiencies and inaccuracies, conventional systems also often suffer from operational inflexibilities. For instance, as noted above, conventional systems typically fail to extend to vectorization in image spaces different from natural images and usually require the use of devices with high GPU/CPU capabilities. Thus, conventional systems are rigidly confined to performing vectorization of digital images for limited types of raster images and on a limited number of devices or device types.

In one or more embodiments, the selective super-resolution system provides several improvements over conventional systems in relation to efficiency, accuracy, and operational flexibility. In some embodiments, the selective super-resolution system improves upon efficiency by applying super-resolution to selected portions of a digital image. Specifically, in contrast to conventional systems that utilize super-resolution for whole images, the selective super-resolution system selects a set of image patches corresponding to high-frequency portions of the digital image and applies the image super-resolution model only to the selected set of image patches with high-frequency data. Specifically, in doing so, the selective super-resolution system selectively upscales image patches using super-resolution, which saves computational resources and speeds up the process of super-resolution. In other words, the selective super-resolution system saves super-resolution for regions of the digital image that would most benefit from super-resolution (e.g., high-frequency portions).

Moreover, in some embodiments, the selective super-resolution system also extends super-resolution capabilities to mobile devices and additional client devices without high GPU/CPU capabilities. Specifically, due to the selective super-resolution system selectively upscaling image patches with the image super-resolution model, the selective super-resolution system is able to operate on devices with lower processing power (e.g., lower GPU/CPU). Thus, in contrast to conventional systems that restrict usage to computing devices with increased processing capabilities, the selective super-resolution system provides raster image vectorization on mobile devices (e.g., smartphones) and reduces processing times on all computing devices.

In one or more embodiments, the selective super-resolution system further improves upon computational accuracy. Specifically, rather than training the image super-resolution model on mostly natural images as in conventional systems, the selective super-resolution system utilizes an augmented training dataset based on image pairs of synthetically modified images. For example, the selective super-resolution system generates a training dataset by determining for a vector image an image pair that includes a rasterized version with aliasing and a rasterized version with anti-aliasing. Moreover, in some instances, the selective super-resolution system further augments additional image pairs utilizing a variety of image augmentations that modify blurring, coloring, or other characteristics of the images. By utilizing the augmented dataset to generate/update parameters of an image super-resolution model, the selective super-resolution system optimizes the image super-resolution model to effectively and accurately upscale image patches corresponding to high-frequency portions across a variety of domains. In other words, the selective super-resolution system trains the image super-resolution model with a wide range of examples to enhance the accuracy of applying super resolution to digital images in the different domains.

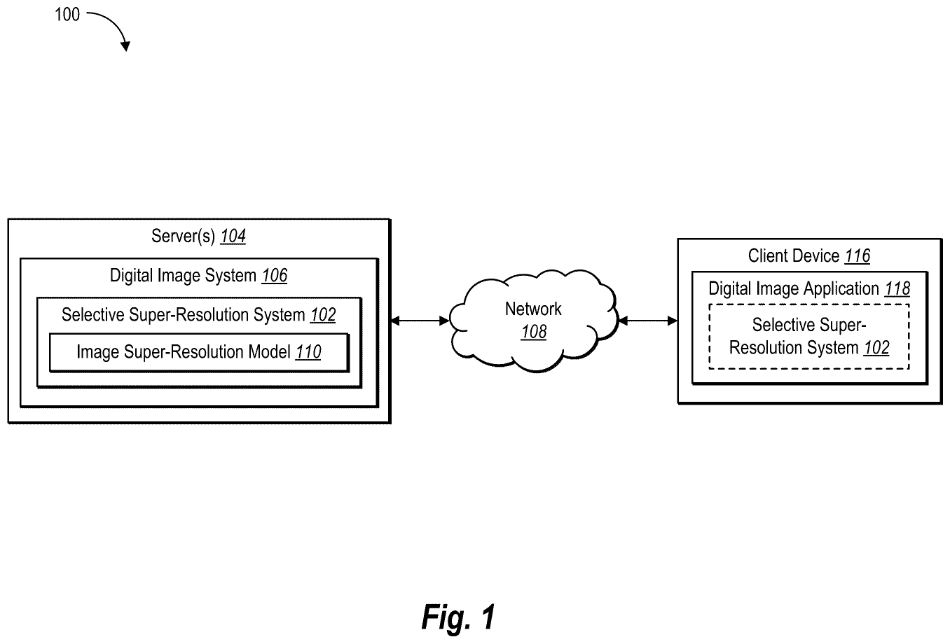

Additional details regarding the selective super-resolution system will now be provided with reference to the figures. For example, FIG. 1 illustrates a schematic diagram of an exemplary system environment 100 in which a selective super-resolution system 102 operates. As illustrated in FIG. 1, the system environment 100 includes server(s) 104, a digital image system 106, a network 108, and a client device 116. Additionally, FIG. 1 illustrates that the digital image system 106 includes the selective super-resolution system 102 and the selective super-resolution system 102 further includes an image super-resolution model 110. Moreover, the client device 116 includes a digital image application 118.

Although the system environment 100 of FIG. 1 is depicted as having a particular number of components, the system environment 100 is capable of having a different number of additional or alternative components (e.g., a different number of servers, client devices, or other components in communication with the selective super-resolution system 102 via the network 108). Similarly, although FIG. 1 illustrates a particular arrangement of the server(s) 104, the network 108, and the client device 116, various additional arrangements are possible.

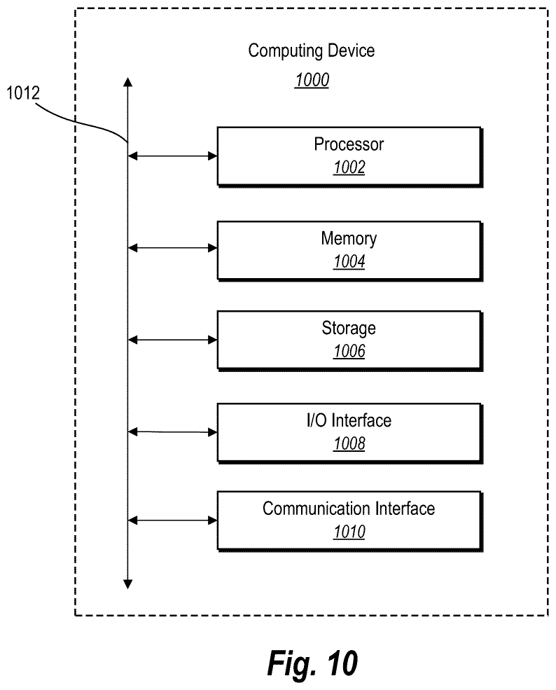

The server(s) 104, the network 108, and the client device 116 are communicatively coupled with each other either directly or indirectly (e.g., through the network 108 discussed in greater detail below in relation to FIG. 10). Moreover, the server(s) 104 and the client device 116 include one or more of a variety of computing devices (including one or more computing devices as discussed in greater detail in relation to FIG. 10).

As mentioned above, the system environment 100 includes the server(s) 104. In one or more embodiments, the server(s) 104 process input for generating a vectorized version of a digital image (e.g., by employing one or more models such as the image super-resolution model 110). In one or more embodiments, the server(s) 104 comprise a data server. In some implementations, the server(s) 104 comprise a communication server or a web-hosting server.

In some embodiments, the client device 116 includes computing devices associated with the one or more user accounts that submit requests to generate vector images from raster images by using the selective super-resolution system 102. For instance, the selective super-resolution system 102 trains the image super-resolution model 110 using a training dataset (e.g., a training dataset containing multiple image pairs) provided from an additional client device. Additionally, the selective super-resolution system 102 utilizes the image super-resolution model 110 to vectorize the raster images (e.g., by selectively upscaling portions of the raster images using the image super-resolution model 110).

In one or more embodiments, the client device 116 includes smartphones, tablets, desktop computers, laptop computers, head-mounted-display devices, or other electronic devices. The client device 116 includes one or more software applications (e.g., the digital image application 118) for generating or modifying digital images in accordance with the digital image system 106. In one or more embodiments, the digital image application 118 includes a software application hosted on the server(s) 104 accessible by the client device 116 through another application, such as a web browser.

To provide an example implementation, in some embodiments, the selective super-resolution system 102 on the server(s) 104 supports the selective super-resolution system 102 on the client device 116. For instance, in some cases, the digital image system 106 on the server(s) 104 gathers data for the selective super-resolution system 102. In response, the selective super-resolution system 102, via the server(s) 104, provides the information to the client device 116. In other words, the client device 116 obtains (e.g., downloads) the selective super-resolution system 102 from the server(s) 104. Once downloaded, the selective super-resolution system 102 on the client device 116 provides tools for performing the vectorization process (e.g., selective upscales high-frequency portions of a digital image using the image super-resolution model 110).

In alternative implementations, the selective super-resolution system 102 includes a web hosting application that allows the client device 116 to interact with content and services hosted on the server(s) 104. To illustrate, in one or more implementations, the client device 116 access a software application supported by the server(s) 104. In response, the selective super-resolution system 102 on the server(s) 104 provides tools for performing the vectorization process.

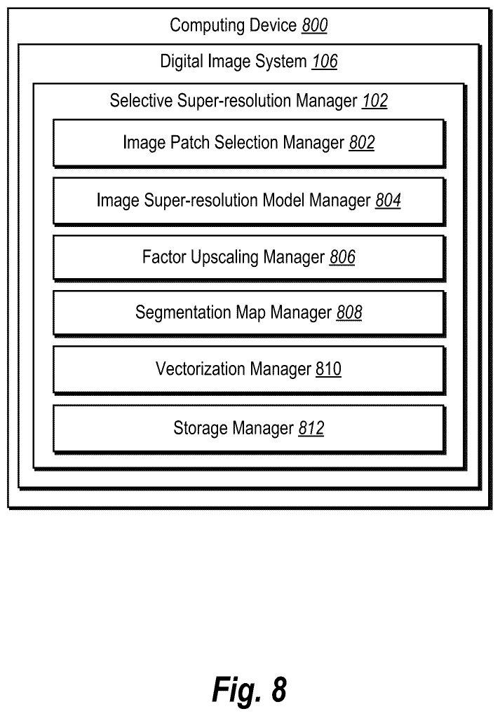

Indeed, in some embodiments, the selective super-resolution system 102 is implemented in whole, or in part, by the individual elements of the system environment 100. For instance, although FIG. 1 illustrates the selective super-resolution system 102 implemented or hosted on the server(s) 104, different components of the selective super-resolution system 102 are able to be implemented by a variety of devices within the system environment 100. For example, one or more (or all) components of the selective super-resolution system 102 are implemented by a different computing device or a separate server from the server(s) 104. Indeed, as shown in FIG. 1, the client device 116 includes the selective super-resolution system 102. Example components of the selective super-resolution system 102 will be described below with regard to FIG. 8.

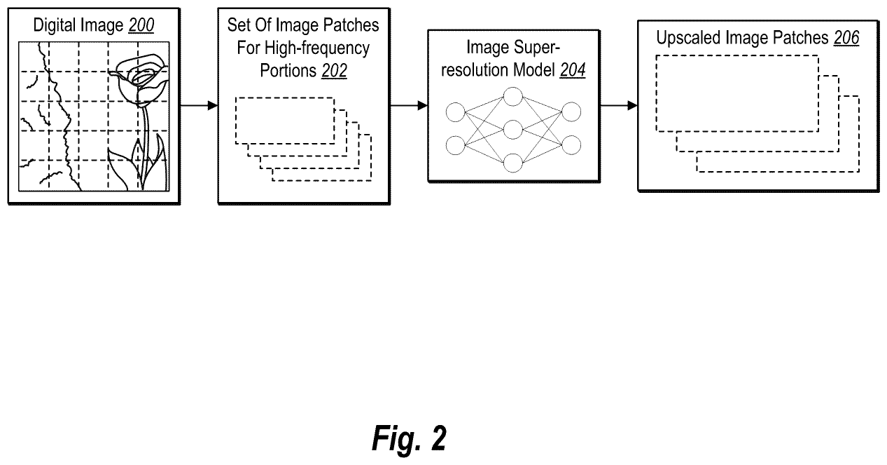

As mentioned above, in certain embodiments, the selective super-resolution system 102 applies an image super-resolution model to portions of a digital image that most benefit from super resolution in connection with segmenting and vectorizing a raster image. FIG. 2 illustrates an example overview of the selective super-resolution system 102 selecting a set of image patches corresponding to high-frequency portions and applying an image super-resolution model to the selected set of image patches in accordance with one or more embodiments.

As shown in FIG. 2, the selective super-resolution system 102 receives a digital image 200. In one or more embodiments, the digital image 200 includes a computer representation of various pictorial elements. In particular, the pictorial elements include pixel values that define the spatial and visual aspects of the digital image 200 such as text and image objects. For example, the digital image 200 is a raster image that includes a grid of pixels. In particular, the raster image includes a fixed resolution as determined by a number of pixels within the digital image 200.

As shown, the selective super-resolution system 102 identifies a set of image patches 202 for high-frequency portions from the digital image 200. In particular, the selective super-resolution system 102 generates a plurality of image patches by sub-dividing the digital image 200 into smaller regions and selecting the set of image patches 202 from the plurality of image patches. For instance, the selective super-resolution system 102 sub-divides the digital image 200 into patches based on a predetermined resolution of the image patches (e.g., 256×256), where each patch represents localized regions of pixels within the digital image 200. In some embodiments, the set of image patches 202 at least partially overlap. In other embodiments, the set of image patches 202 do not overlap. In some embodiments, an image patch of the set of image patches overlaps with pixel values of an adjacent image patch.

Moreover, as shown, the selective super-resolution system 102 applies an image super-resolution model 204 to the set of image patches 202 corresponding to the high-frequency portions. In one or more embodiments, the image super-resolution model 204 is, or includes, a neural network. Specifically, a neural network includes a machine learning model of interconnected artificial neurons (e.g., organized in layers) that communicate and learn to approximate complex functions and generate outputs based on a plurality of inputs provided to the model. In some instances, a neural network includes an algorithm (or set of algorithms) that implements deep learning techniques that utilize a set of algorithms to model high-level abstractions in data. To illustrate, in some embodiments, a neural network includes a convolutional neural network, a recurrent neural network (e.g., a long short-term memory neural network), a transformer neural network, a deep learning neural network, a residual neural network, a generative adversarial neural network, a graph neural network, a diffusion neural network, or a multi-layer perceptron. In some embodiments, the image super-resolution model 204 includes a combination of neural networks or neural network components (e.g., a plurality of transformer neural networks and/or one or more deep learning neural networks).

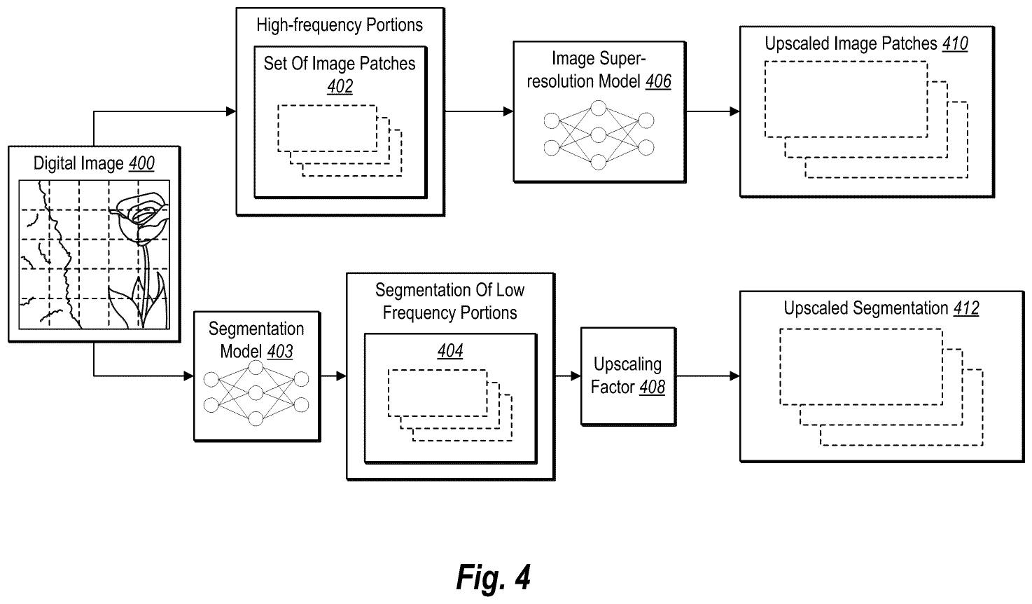

In some embodiments, the selective super-resolution system 102 trains the image super-resolution model 204 on an augmented training dataset including a set of modified images generated by the selective super-resolution system 102. In particular, the selective super-resolution system 102 utilizes the image super-resolution model 204 to increase an initial resolution of portions of the digital image 200 to a higher resolution (e.g., higher by at least an upscaling factor of two). For instance, the selective super-resolution system 102 utilizes the image super-resolution model 204 to fill in details of the portions of the digital image 200 when upscaled to the higher resolution (e.g., the selective super-resolution system 102 selectively utilizes the image super-resolution model 204 to upscale high-frequency portions of the digital image 200). For example, the selective super-resolution system 102 utilizes the image super-resolution model 204 to generate new pixels based on pixels of the high-frequency image patches according to the higher resolution and assign pixel values to the new pixels at the higher resolution. Additional details are given below in the description of FIG. 4.

As further shown, the selective super-resolution system 102 generates upscaled image patches 206 from the set of image patches 202 corresponding to the high-frequency portions of the digital image 200. In one or more embodiments, the upscaled image patches 206 include patches that the selective super-resolution system 102 generates by increasing the size and resolution of the set of image patches 202 of the high-frequency portions of the digital image 200. In particular, the selective super-resolution system 102 generates upscaled image patches 206 for the high-frequency portions by adding pixels or subdividing existing pixels according to the relative increase in resolution. As is described in more detail below in FIG. 4, the selective super-resolution system 102 uses the image super-resolution model 204 to perform upscaling for high-frequency portions and generates a segmentation of low-frequency portions and further upscales the segmentation of the low-frequency portions according to an upscaling factor.

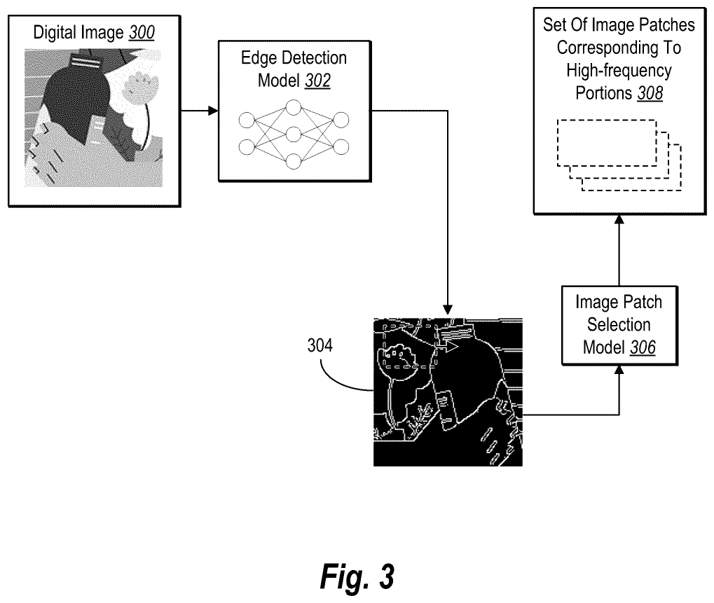

As mentioned above, in certain embodiments, the selective super-resolution system 102 uses edge detection to identify the high-frequency portions of a digital image. FIG. 3 illustrates an example diagram of the selective super-resolution system 102 using an edge detection model to generate an edge map indicating high-frequency image data in accordance with one or more embodiments. Specifically, as shown, the selective super-resolution system 102 receives a digital image 300 and further utilizes an edge detection model 302 to generate an edge map 304.

In one or more embodiments, the edge detection model 302 includes a computer vision model that identifies boundaries of objects in a digital image. For instance, the selective super-resolution system 102 utilizes the edge detection model 302 to detect edges by computing an image gradient (e.g., vectors that point in the direction of the maximum change of brightness) that indicates changes in brightness levels or pixel intensity across the digital image. For example, the selective super-resolution system 102 computes the image gradient by applying a filter to remove noise from the digital image, computing the horizontal and vertical gradients of the image, and identifying the edge strength and direction for each pixel by combining the horizontal and vertical gradients.

As mentioned, the selective super-resolution system 102 utilizes the edge detection model 302 to generate the edge map 304. In one or more embodiments, the edge map 304 includes a binary image (e.g., with pixel values of 1s and 0s) that depicts locations of edges in the digital image 300. In particular, the edge map 304 indicates where the image brightness changes sharply or where discontinuities occur (e.g., changes in regions or objects).

As shown, the selective super-resolution system 102 utilizes an image patch selection model 306 to minimize the number of selected image patches. Specifically, the selective super-resolution system 102 minimizes a number of image patches (e.g., while covering all the high-frequency data in the digital image) in a set of image patches 308 corresponding to high-frequency portions for a predetermined image patch size.

In one or more embodiments, the selective super-resolution system 102 utilizes the edge detection model 302 to generate the edge map 304 that includes the high-frequency information. The selective super-resolution system 102 selects an initial set of image patches that includes the high-frequency information. In particular, the high-frequency portions refer to areas within the digital image 300 that include a rapid change in intensity or color. For instance, the high-frequency portions indicate edges or boundaries between different objects or regions in the digital image 300. To illustrate, the high-frequency portions include sharp transitions between light pixel values and dark pixel values. For example, the selective super-resolution system 102 generates the edge map 304 from the digital image 300 and utilizes the edge map 304 to identify the high-frequency portions.

In one or more embodiments, the selective super-resolution system 102 utilizes a sliding window operation (or another patch selection operation) an image patch size to slide through the edge map 304 to identify image patches that include high-frequency information. For instance, the selective super-resolution system 102 utilizes the sliding window operation to detect a first plurality of image patches of the digital image 300 including high-frequency image data, where each image patch further includes the data from the edge map 304.

As mentioned, the selective super-resolution system 102 utilizes the edge detection model 302 to generate the edge map 304. In one or more embodiments, the edge map 304 indicates boundaries of objects in the digital image 300 and the intensity of the lightness value changes. In some embodiments, the selective super-resolution system 102 utilizes a density threshold for the edge map 304 to determine high-frequency information by utilizing a predetermined cutoff point for the magnitude of change between light pixel values and dark pixel values. For instance, the selective super-resolution system 102 utilizes the density threshold to determine which image patches of the digital image 300 correspond to high-frequency portions.

Moreover, in response to identifying the initial set of high-frequency image patches, the selective super-resolution system 102 utilizes the image patch selection model 306 including a greedy algorithm such as non-maximum suppression (NMS) to filter out redundant detections to maintain only the most relevant detections. For instance, the selective super-resolution system 102 uses the image patch selection model 306 to sort the first plurality of image patches based on the edge map data and further compares the intersection over union of the plurality of image patches to identify redundancies (e.g., overlapping portions). In some embodiments, the selective super-resolution system 102 iteratively repeats this process using the image patch selection model 306 (e.g., generates additional iterations, such as a second plurality of image patches for the digital image 300) until a minimal number of image patches that covers all the high-frequency regions are identified. Although the non-maximum suppression model is described here, in other embodiments, the selective super-resolution system 102 utilizes one or more other image patch selection algorithms to identify the high-frequency portions of the digital image 300.

As mentioned above, the selective super-resolution system 102 upscales a segmentation of low-frequency portions and utilizes an image super-resolution model for high-frequency portions of a digital image. FIG. 4 illustrates an example diagram of the selective super-resolution system 102 using an image super-resolution model for high-frequency image patches and upscaling a segmentation of the low-frequency portions in accordance with one or more embodiments.

As discussed in detail above, the selective super-resolution system 102 receives a digital image 400 and further selects a set of image patches 402 for high-frequency portions using an edge detection model. As further shown, the selective super-resolution system 102 selects the remaining image patches from the digital image 400 that correspond to low-frequency portions. In other words, the selective super-resolution system 102 of the digital image 400 selects separate image patches that correspond to the high-frequency portions and the low-frequency portions. In particular, the low-frequency portions indicate portions of the digital image 400 without sharp changes in intensity or brightness levels. Furthermore, in some embodiments, the set of image patches 402 including high-frequency image data is the inverse of a set of image patches corresponding to low-frequency image data.

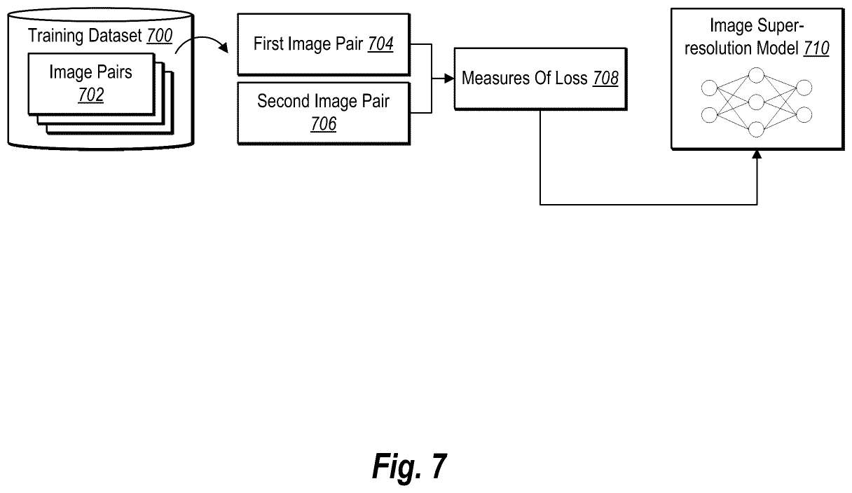

As shown, for the set of image patches 402 that corresponds to the high-frequency portions, the selective super-resolution system 102 utilizes an image super-resolution model 406 to upscale the set of image patches 402. In some embodiments, the image super-resolution model 406 is trained on an augmented dataset in the manner discussed below in FIGS. 7-8. Moreover, as shown, for a set of image patches corresponding to the low-frequency portions, the selective super-resolution system 102 uses a segmentation model 403 to generate a segmentation of low-frequency portions 404 and further upscales the segmentation of low-frequency portions 404 according to an upscaling factor 408. In some embodiments, the selective super-resolution system 102 utilizes the upscaling factor 408 (e.g., according to an upscaling factor of two) to generate an upscaled segmentation 412 of the low-frequency portions.

As shown, the selective super-resolution system 102 utilizes the image super-resolution model 406 to generate first upscaled image patches 410 and the segmentation model 403 to generate the segmentation of low-frequency portions, which the selective super-resolution system 102 upscales to generate the upscaled segmentation 412. Specifically, upscaled image patches refers to image patches of the digital image 400 with an increase in resolution relative to an initial resolution. In one or more embodiments, a resolution of the digital image 400 refers to a level of detail or sharpness of the digital image 400. In particular, the resolution of the digital image 400 includes a number of pixels in the digital image 400. For instance, more pixels in the digital image 400 indicates a higher resolution. In some embodiments, the selective super-resolution system 102 generates the upscaled image patches to a higher resolution according to an upscaling factor of at least two (e.g., two to five or more). In some embodiments, the selective super-resolution system 102 generates upscaled image patches to a higher resolution according to an upscaling factor greater than one.

To illustrate, the selective super-resolution system 102 utilizes the image super-resolution model 406 including one or more residual neural networks trained in the specific manner described below in FIGS. 7-8. For example, the selective super-resolution system 102 utilizes the image super-resolution model 406 to extract hierarchical features from all convolution layers to utilize the deep convolutional neural network architecture more fully. For instance, the selective super-resolution system 102 implements the super-resolution model as described in Prafull Sharma, Julien Philip, Michael. Gharbi, Bill Freeman, Fredo Durand, and Valentin Deschaintre, “Materialistic: Selecting Similar Materials in Images,” In: ACM Trans. Graph, 42.4 (July 2023), which is fully incorporated by reference herein. In alternative embodiments, the image super-resolution model 406 includes a neural network including one or more deep learning neural networks, transformer neural networks, residual neural networks, or other neural network layers to upscale the digital image 400 to a higher resolution by a particular upscaling factor.

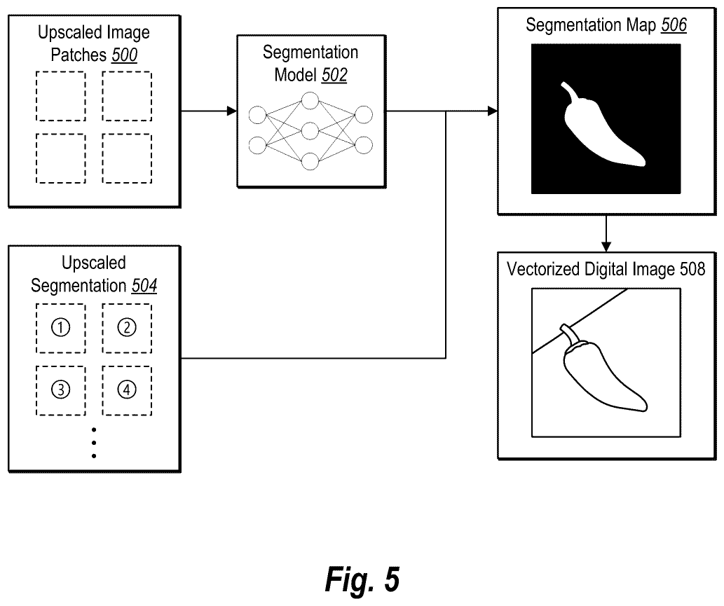

As mentioned above, the selective super-resolution system 102 generates a segmentation map. FIG. 5 illustrates an example diagram of the selective super-resolution system 102 combining a segmentation of the upscaled image patches of the high-frequency portions and the upscaled segmentation of the low-frequency portions to generate the segmentation map in accordance with one or more embodiments.

As shown in FIG. 5, the selective super-resolution system 102 takes upscaled image patches 500 (e.g., that correspond to high-frequency portions) and utilizes a segmentation model 502 to generate a segmentation of the upscaled image patches 500. Furthermore, as shown, the selective super-resolution system 102 combines an upscaled segmentation 504 (e.g., of the low-frequency portions) with the segmentation of the upscaled image patches 500. For instance, from the combination, the selective super-resolution system 102 generates a segmentation map 506 from the combination of the upscaled segmentation 504 and the segmentation of the upscaled image patches 500.

To illustrate, the selective super-resolution system 102 stitches the segmentation of the upscaled image patches with the upscaled segmentation 504 together by identifying coordinates of the image patches prior to upscaling. Specifically, the selective super-resolution system 102 identifies coordinates of the image patches for the high-frequency portion and the coordinates of the image patches for the low-frequency portions. Moreover, the selective super-resolution system 102 utilizes the image super-resolution model for the image patches of the high-frequency portions and determines coordinates for the first upscaled image patches 500 according to the super resolution applied by the image super-resolution model. Similarly, the selective super-resolution system 102 generates a segmentation for the image patches of the low-frequency portions and determines updated coordinates for the upscaled segmentation according to the upscaling factor. Thus, the selective super-resolution system 102 pieces together the segmentation map 506 with the new coordinates for the segmentation of the upscaled image patches 500 and the upscaled segmentation 504.

In one or more embodiments, the segmentation map 506 includes a representation of a digital image that divides the digital image into regions. In particular, the segmentation map 506 indicates different regions corresponding to different objects in the digital image or regions (e.g., background/foreground). For example, the segmentation map 506 includes utilizing a segmentation model to assign a label to each pixel of a digital image, where the label indicates an object or region that the pixel belongs to. To illustrate, FIG. 5 shows the segmentation map 506 as segmenting the object (e.g., the pepper) from the background. In some embodiments, the selective super-resolution system 102 generates the segmentation map 506 by identifying different regions corresponding to different pixel values (or to ranges of different pixel values).

As shown in FIG. 5, the selective super-resolution system 102 further generates a vectorized digital image 508 according to the segmentation map 506. Specifically, the selective super-resolution system 102 utilizes the segmentation map 506 to further perform curve tracing through boundary pixels (e.g., as part of the vectorization pipeline). For instance, the selective super-resolution system 102 achieves sub-pixel accuracy by utilizing the image super-resolution model for high-frequency portions to accurately trace vector lines for thin or small boundaries/regions of objects (e.g., corresponding to high-frequency portions) in a raster image. In other words, by utilizing the image super-resolution model for the high-frequency portions, the selective super-resolution system 102 has additional freedom to trace a boundary at a sub-pixel level (e.g., a single pixel is subdivided into multiple pixels).

As just mentioned, the selective super-resolution system 102 (e.g., as part of the vectorization pipeline), generates the segmentation map 506, performs curve tracing, and further generates the vectorized digital image 508. For example, the vectorized digital image 508 includes various mathematical equations to define lines, shapes, and curves (e.g., Bezier curves). In particular, the vectorized digital image 508 includes a resolution-independent image. For instance, scaling up or down the vectorized digital image 508 does not result in a loss of quality.

In some embodiments, the selective super-resolution system 102 generates the vectorized digital image 508, which removes anti-aliasing (e.g., color blending to soften the appearance of jagged edges in rasterized images) and compression artifacts (e.g., artifacts that result from discarding image data) from a raster image. Specifically, the selective super-resolution system 102 performs the actions described in FIGS. 1-5 to selectively upscale the high-frequency portions with the image super-resolution model and upscale a segmentation of the low-frequency portions according to an upscaling factor. The selective super-resolution system 102 further vectorizes the segmentation map 506 to remove anti-aliasing and the compression artifacts.

FIGS. 1-5 describe the selective super-resolution system 102 selectively upscaling high-frequency patches with the image super-resolution model and upscaling a segmentation of low-frequency patches according to an upscaling factor to generate a segmentation map and subsequently the vectorized digital image 508. In some embodiments, the selective super-resolution system 102 represents a digital image (e.g., a raster image) as a two 2-dimensional array of pixels, where each pixel has 3 channel colors, namely red, blue and green. Specifically, for an image with height H∈N and width W∈N, the selective super-resolution system 102 treats each pixel as uniquely identified by its position in a 2-dimensional grid. The set of pixels P_{I} is defined as,

$${P}_{I} : = [ 0 … H ) \times [ 0 … W )$$

In the above representation, the set P_{I} is a strict subset of [symbol] ². Thus, a raster image is a map from pixel to a color, represented as:

$$I : {P}_{I} \to {ℝ}^{3}$$

In other words, the image is represented by a three-dimensional Euclidean space (x, y, z).

Furthermore, the selective super-resolution system 102 treats the adjacency of a pixel as dictated by the connectivity criterion. For instance, in a 4-connected criteria, every pixel (i, j) is adjacent to four pixels, represented as:

$$\{ ( i - 1 , j ) , ( i + 1 , j ) , ( i , j - 1 ) , ( i , j + 1 ) \}$$

Similarly, in a 8-connected setting, there are 8 adjacent pixels, represented as:

$$\{ ( i - 1 , j ) , ( i + 1 , j ) , ( i , j - 1 ) , ( i , j + 1 ) , ( i - 1 , j - 1 ) , ( i + 1 , j - 1 ) , ( i + 1 , j + 1 ) , ( i + 1 , j - 1 ) \}$$

Moreover, a path is a sequence of pixels {pᵢ, . . . , pₙ} such that, for every pixel pᵢ in the sequence, pᵢ is adjacent to pᵢ₋₁ and pᵢ₊₁ (if they exist).

In some embodiments, the selective super-resolution system 102 utilizes a segmentation of a raster image as a defined map from pixels to natural numbers, represented as:

$${S}_{I} : {P}_{I} \to N$$

Thus, the above representation indicates that the selective super-resolution system 102 assigns each pixel a non-negative number referred to as a segment identifier. Further, in some embodiments, the partition Pt of the pixels induced by the segmentation is the equivalence class defined by the equivalence relation whether they have the same segment identifier, represented as:

$$Pt := {\{ \{ p ∈ P : S ( p ) = n \} : n ∈ ℕ \}}^{1}$$

The above representation indicates that S and P_{T} are equivalent. In other words, the selective super-resolution system 102 derives S from P_{T} and vice versa. Accordingly, a segmentation indicates both the map and the corresponding partition.

Moreover, in some embodiments, the selective super-resolution system 102 utilizes fill functions to increase the resolution of a digital image. For instance, a fill function includes an algorithm or technique used to interpolate or generate additional pixel values to enhance a raster image to a higher resolution (e.g., relative to an initial resolution of the raster image). Specifically, the selective super-resolution system 102 utilizes fill functions defined as a set of tuple of functions, represented as:

$$F : = \{ f \vert f : B \to {ℝ}^{3} , B ⊆ {ℝ}^{2} \}$$

In the above representation, the color function f is a mapping from points in [symbol] ² to the color space [symbol] ³ and the domain of f is B (e.g., B indicates a subset of the two-dimensional Euclidean space ( [symbol] ²). Additionally, the selective super-resolution system 102 denotes the domain of a function by Dom(f) and considers the discrete domain P_{I} for a given image I, represented as:

$${F}_{I} = \{ f \vert f : B \to {ℝ}^{3} , B ⊆ {P}_{I} \}$$

In the above representation, B indicates a subset of the partition P_{I} of the pixels induced by the segmentation. Furthermore, the selective super-resolution system 102 considers F a function as well, with domain Dom (F)=U_{f∈F} Dom(f) and co-domain in [symbol] ³.

$$F ( p ) = {{\sum }_{f ∈ F}}_{p ∈ Dom ( f )} f ( p )$$

Moreover, the selective super-resolution system 102 considers fill functions where the domain functions are non-overlapping, represented as:

$${∀}_{{f}_{1} , {f}_{2} ∈ F} Dom ( {f}_{1} ) ⋂ Dom ( {f}_{2} ) \neq ∅ ⇒ {f}_{1} = {f}_{2}$$

As mentioned, the above representations indicate the selective super-resolution system 102 interpolating or generating additional pixels for the raster image according to a higher resolution (e.g., relative to an initial resolution). The following description includes additional details of the selective super-resolution system 102 generating the segmentation map 506.

In some embodiments, the selective super-resolution system 102 converts an image patch of 128×128 to 256×256 (or 512×512) by effectively mapping each pixel to 4 (or 16) pixels. Specifically, the selective super-resolution system 102 breaks the raster image into image patches of 128×128 with overlap. For example, the selective super-resolution system 102 partitions a set of pixels (P) of an image (I) into two sets Pₗ (e.g., pixels from parts of the image where the color varies smoothly) and Pₕ (e.g., pixels with high-frequency details).

To illustrate, the selective super-resolution system 102 first constructs fill functions Fₗ:Pₗ→ [symbol] ³, which represents a function for the low-frequency details mapped to the three-dimensional Euclidean space. From the fill function, the selective super-resolution system 102 generates a partition Pₜ_{ₗ} (and the corresponding segmentation Sₗ) of Pₗ. For instance, the selective super-resolution system 102 segments the low-frequency details utilizing the methods described in Souymodip Chakraborty, Vineet Batra, Ankit Phogat, Vishwas Jain, and Jaswant Singh Ranawat, “Solid Image Segmentation,” 2023, pages 8-10, which is incorporated fully herein by reference.

Furthermore, the selective super-resolution system 102 lifts Fₗ (the segmentation of the low-frequency details) to a new pixel space Q, represented as:

$$Q : = [ 0 , … , γ \cdot H ) \times [ 0 , … , γ \cdot W )$$

Where γ∈N is the up-scale factor and the up-scale relation Y⊆P×Q such that:

$$( p , q ) ∈ Y iff ∃ k ∈ ℕ : k \cdot p \leq q < ( k + 1 ) \cdot p$$

Where < and ≤ are pair-wise comparison operators.
Let Fₗ: ={f₁, . . . , fₙ}, and the lifted fill functions are defined as Fₗ*: ={f₁*, . . . , fₙ*}, where:

$$Dom ( {f}_{i}^{*} ) : = {\{ \begin{matrix}q : & ∃ & pYq\end{matrix} \}}_{p ∈ Dom ( {f}_{i} )}$$

The value of the lifted function f* is derived from f as follows:

$$f * ( q ) : = f ( \frac{q}{γ} )$$

In other words, the segmentation of the low-frequency portions of the raster image are upscaled according to the upscaling factor (γ). Further, the domains of F* is a partition on the subset of Q, denoted by Qₗ. The set Qₗ contains pixels that are obtained from the smooth regions of the original image, and the high-frequency details are in Qₕ:=Q\Qₗ.

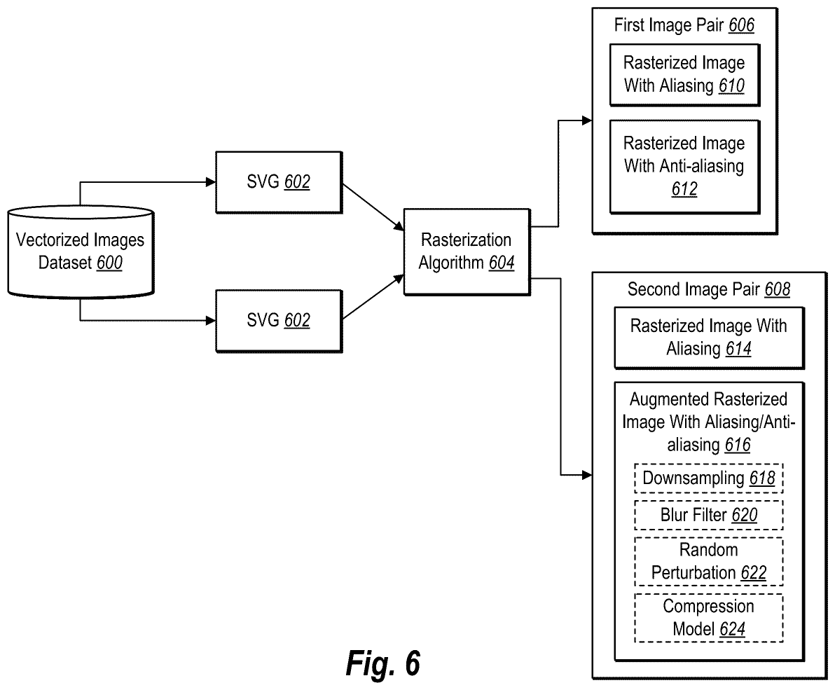

As mentioned above, the selective super-resolution system 102 trains the image super-resolution model on an augmented dataset. FIG. 6 illustrates an example diagram of the selective super-resolution system 102 generating image pairs in accordance with one or more embodiments. Specifically, FIG. 6 shows the selective super-resolution system 102 accessing a vectorized images dataset 600 and selecting a SVG 602 (e.g., a scalable vector graphic, hereinafter referred to as “SVG”).

As shown in FIG. 6, the selective super-resolution system 102 utilizes a rasterization algorithm 604 to rasterize the SVG 602. Specifically, the selective super-resolution system 102 utilizes the rasterization algorithm 604 to generate a first image pair 606. For instance, the first image pair 606 includes a rasterized image with aliasing 610 and a rasterized image with anti-aliasing 612. As mentioned above, an image with anti-aliasing includes modified pixel values to remove the appearance of jagged edges in a rasterized image (e.g., pixels at the edge of boundaries or objects get color values from neighboring pixels). In contrast, an image with aliasing includes the selective super-resolution system 102 not removing the appearance of jagged edges (e.g., not employing any anti-aliasing tools).

Further, as shown, the selective super-resolution system 102 also generates a second image pair 608 that includes a rasterized image with aliasing 614 and an augmented rasterized image with aliasing/anti-aliasing 616. Specifically, the augmented rasterized image with aliasing/anti-aliasing 616 further contains one or more augmentations 618-624 to either a rasterized image with aliasing and/or a rasterized image with anti-aliasing. To illustrate, the perturbations include downsampling 618 and upsampling the downsampled image, blur filter 620, random perturbation 622 (e.g., modifying color properties), and a compression model 624.

In some embodiments, the downsampling 618 includes reducing the size of the rasterized image with aliasing/anti-aliasing. In particular, the downsampling 618 includes reducing the size between one-third and one-half of the initial size. In some embodiments, upsampling includes increasing the size of the rasterized image with aliasing/anti-aliasing after the downsampling 618. In particular, the upsampling includes increasing the size back to the initial size.

Further, in some embodiments, the selective super-resolution system 102 applies the blur filter 620 to the rasterized image with aliasing/anti-aliasing. In particular, the blur filter 620 distorts or blurs pixels in the rasterized image. For instance, the selective super-resolution system 102 applies a gaussian filter with a random radius to the rasterized image with aliasing/anti-aliasing. Moreover, in some embodiments, the selective super-resolution system 102 perturbs a color property of the rasterized image with aliasing/anti-aliasing. In particular, the selective super-resolution system 102 perturbs the color property by changing the image brightness, contrast, saturation, hue, and/or gamma properties.

Additionally, in some embodiments, the selective super-resolution system 102 applies the compression model 624 to the rasterized image with aliasing/anti-aliasing. In particular, the selective super-resolution system 102 utilizes the compression model 624 (e.g., a JPEG compression model) to discard image data (e.g., to reduce size). For instance, compressed images typically include noisy artifacts, smearing, and blurring due to the discarded image data. Accordingly, from the various perturbations/augmentations, the selective super-resolution system 102 curates/augments a diverse training dataset for learning parameters of the image super-resolution model to perform efficient super resolution of high-frequency portions of a raster image.

As mentioned above, the selective super-resolution system 102 adjust/learns parameters of the image super-resolution model. FIG. 7 shows an example diagram of the selective super-resolution system 102 adjusting parameters of the image super-resolution model based on generated image pairs from a training dataset in accordance with one or more embodiments.

As shown, the selective super-resolution system 102 accesses a training dataset 700 that includes image pairs 702. Specifically, the training dataset 700 includes various generated image pairs utilizing the processes described in FIG. 6. For example, from a first image pair 704 and a second image pair 706, the selective super-resolution system 102 determines measures of loss 708 and adjusts parameters of an image super-resolution model 710. In particular, the measures of loss 708 include L1 loss, mean squared error loss, cross-entropy loss, Kullback-Leibler divergence loss, or hinge loss. In some embodiments, the selective super-resolution system 102 generates a measure of loss from the first image pair 704, and an additional measure of loss from the second image pair 706. To illustrate, the selective super-resolution system 102 determines the measures of loss 708 by comparing the rasterized image with aliasing to the rasterized image with anti-aliasing in the first image pair 704. Additionally, the selective super-resolution system 102 determines the measures of loss 708 by comparing the rasterized image with aliasing to a modified rasterized image with one or more perturbations.

In one or more embodiments, the selective super-resolution system 102 takes the first image pair 704 and utilizes an edge detection model to generate edge maps of the rasterized image with aliasing and the rasterized image with anti-aliasing. Further, the selective super-resolution system 102 selects image patches for high-frequency portions based on the edge maps and upscales the high-frequency image patches using the image super-resolution model. Moreover, the selective super-resolution system 102 generates upscaled images patches (e.g., for the rasterized image with aliasing and the rasterized image with anti-aliasing) to determine the measures of loss 708 on only high-frequency portions of the image pairs 702.

Accordingly, the selective super-resolution system 102 determines the measures of loss 708 by comparing the upscaled image patches of the rasterized image with anti-aliasing to the upscaled image patches of the rasterized image with aliasing (e.g., the ground truth). From the measures of loss 708, the selective super-resolution system 102 adjusts the parameters of the image super-resolution model 710 to optimize the model to effectively upscale high-frequency portions of digital images. In other words, the selective super-resolution system 102 employs the image super-resolution model 710 to remove noise, remove compression artifacts, and upscale the image achieving super-resolution.

Turning to FIG. 8, additional detail will now be provided regarding various components and capabilities of the selective super-resolution system 102. In particular, FIG. 8 illustrates an example schematic diagram of a computing device 800 (e.g., the server(s) 104 and/or the client device 116) implementing the selective super-resolution system 102 in accordance with one or more embodiments of the present disclosure for components 900-912. As illustrated in FIG. 8, the selective super-resolution system 102 includes an image patch selection manager 802, an image super-resolution model manager 804, a factor upscaling manager 806, a segmentation map manager 808, a vectorization manager 810, and a storage manager 812.

The image patch selection manager 802 selects a set of image patches from a digital image. For example, the image patch selection manager 802 utilizes an edge detection model to generate an edge map of the digital image. Further, from the edge map, the image patch selection manager 802 selects a set of image patches that correspond to high-frequency portions of a digital image. For instance, the image patch selection manager 802 utilizes a density threshold (e.g., as a cut-off point) for determining which portions/regions of a digital image are considered high-frequency. Moreover, the image patch selection manager 802 employs greedy methods to minimize the number of image patches part of the set of image patches that include all the high-frequency portions in the digital image.

The image super-resolution model manager 804 generates upscaled image patches. For example, the image super-resolution model manager 804 receives the set of image patches corresponding to the high-frequency portions of the digital image and further generates upscaled image patches using an image super-resolution model. Specifically, the image super-resolution model manager 804 generates the upscaled image patches to a higher resolution relative to an initial resolution of the image patches (e.g., an upscaling factor of at least two). In some instances, the image super-resolution model manager 804 further manages the training of the image super-resolution model. For example, the image super-resolution model manager 804 generates the training dataset that includes various image pairs with or without perturbations and adjusts parameters of the image super-resolution model through various iterations of training.

The factor upscaling manager 806 generates upscaled segmentations for image patches for low-frequency portions. Specifically, the selective super-resolution system 102 receives a segmentation of the image patches corresponding to low-frequency portions of the digital image and passes them to the factor upscaling manager 806. The factor upscaling manager 806 generates upscaled segmentations corresponding to the low-frequency portions according to an upscaling factor.

The segmentation map manager 808 generates a segmentation map of the digital image. Specifically, the segmentation map manager 808 utilizes a segmentation of the upscaled image patches for the high-frequency portions and the upscaled segmentation of the low-frequency portions to generate an upscaled digital image. Accordingly, the segmentation map manager 808 utilizes a segmentation model to generate a segmentation map to generate segmentations of low-frequency portions at an initial resolution of a digital image and segmentations of high-frequency portions at a higher resolution.

The vectorization manager 810 generates vectorized images for the digital image according to the segmentation map. Specifically, the vectorization manager 810 manages the vectorization pipeline in response to receiving the segmentation map. For example, the vectorization manager 810 performs tasks such as curve tracing and converting various elements of the digital image into vector elements (e.g., Bezier curves) according to the segmentation map. Accordingly, the vectorization manager 810 generates the vectorized version of the digital image and provides the vector image to a digital image application.

The storage manager 812 stores various components discussed in FIG. 8. For example, the storage manager 812 stores the image super-resolution model, digital images (e.g., raster images), image patches, edge maps, and density thresholds. Additionally, the storage manager 812 also stores training components such as a training dataset and the generated image pairs.

Each of the components 902-912 of the selective super-resolution system 102 include software, hardware, or both. For example, the components 902-912 include one or more instructions stored on a computer-readable storage medium and executable by processors of one or more computing devices, such as a client device or server device. When executed by the one or more processors, the computer-executable instructions of the selective super-resolution system 102 cause the computing device(s) to perform the methods described herein. Alternatively, the components 902-912 include hardware, such as a special-purpose processing device to perform a certain function or group of functions. Alternatively, the components 902-912 of the selective super-resolution system 102 include a combination of computer-executable instructions and hardware.

Furthermore, the components 902-912 of the selective super-resolution system 102 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 902-912 of the selective super-resolution system 102 may be implemented as a stand-alone application, such as a desktop or mobile application. Furthermore, the components 902-912 of the selective super-resolution system 102 may be implemented as one or more web-based applications hosted on a remote server. Alternatively, or additionally, the components 902-912 of the selective super-resolution system 102 may be implemented in a suite of mobile device applications or “apps.” For example, in one or more embodiments, the selective super-resolution system 102 comprise or operate in connection with digital software applications such as ADOBE® ILLUSTRATOR®.

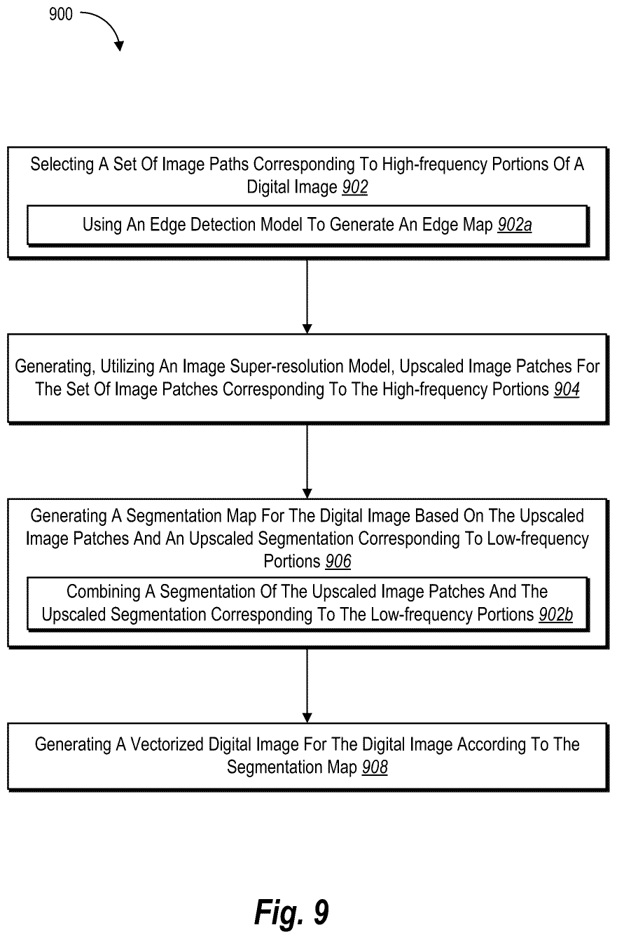

FIGS. 1-9, the corresponding text, and the examples provide a number of different methods, systems, devices, and non-transitory computer-readable media of the 902-912. In addition to the foregoing, one or more embodiments are described in terms of flowcharts comprising acts for accomplishing the particular result, as shown in FIG. 9. FIG. 9 may be performed with more or fewer acts. Further, the acts may be performed in different orders. Additionally, the acts described herein may be repeated or performed in parallel with one another or in parallel with different instances of the same or similar acts.

FIG. 9 illustrates a flowchart of a series of acts 900 for generating a vectorized digital image in accordance with one or more embodiments. FIG. 9 illustrates acts according to one embodiment, alternative embodiments may omit, add to, reorder, and/or modify any of the acts shown in FIG. 9. In some implementations, the acts of FIG. 9 are performed as part of a method. For example, in some embodiments, the acts of FIG. 9 are performed as part of a computer-implemented method. Alternatively, a non-transitory computer-readable medium stores instructions thereon that, when executed by at least one processor, cause a computing device to perform the acts of FIG. 9. In some embodiments, a system performs the acts of FIG. 9. For example, in one or more embodiments, a system includes at least one memory device. The system further includes at least one server device configured to cause the system to perform the acts of FIG. 9.

The series of acts 900 includes an act 902 of selecting a set of image paths corresponding to high-frequency portions of a digital image. Moreover, the act 902 includes a sub-act 902a of using an edge detection model to generate an edge map. Further, the series of acts 900 includes an act 904 of generating, utilizing an image super-resolution model, upscaled image patches for the set of image patches corresponding to the high-frequency portions. Moreover, the series of acts 900 includes an act 906 of generating a segmentation map for the digital image based on the t upscaled image patches and an upscaled segmentation corresponding to low-frequency portions. Further, the act 906 includes a sub-act 902b of combining the upscaled image patches and the upscaled segmentation corresponding to the low-frequency portions. Moreover, the series of acts 900 includes an act 908 of generating a vectorized digital image for the digital image according to the segmentation map.

In particular, the act 902 includes selecting, by at least one processor, a set of image patches corresponding to high-frequency portions of a digital image at a first resolution. Further, the act 904 includes generating, by the at least one processor utilizing an image super-resolution model, upscaled image patches for the set of image patches corresponding to the high-frequency portions to a second resolution higher than the first resolution according to an upscaling factor of at least two. Moreover, the act 906 includes generating, by the at least one processor, a segmentation map for the digital image based on the upscaled image patches and an upscaled segmentation corresponding to low-frequency portions of the digital image. Further, the act 908 includes generating, by the at least one processor, a vectorized digital image for the digital image according to the segmentation map.

For example, in one or more embodiments, the series of acts 900 includes generating, utilizing an edge detection model, an edge map that indicates the high-frequency portions and the low-frequency portions of the digital image based on detected edges in the edge map. In addition, in one or more embodiments, the series of acts 900 includes selecting the set of image patches from the digital image according to the high-frequency portions indicated by the edge map. Further, in one or more embodiments, the series of acts 900 includes determining, using the edge map, the set of image patches that minimizes a number of image patches in the set of image patches corresponding to the high-frequency portions for a predetermined image patch size. Further, in some embodiments, the series of acts 900 includes generating a training dataset by determining, for a vector image, an image pair comprising a first rasterized image with aliasing and a second rasterized image with anti-aliasing. Moreover, in some embodiments, the series of acts 900 includes adjusting parameters of the image super-resolution model based on the first rasterized image and the second rasterized image.

Moreover, in one or more embodiments, the series of acts 900 includes adjusting the parameters of the image super-resolution model to reduce an output of a loss function determined by comparing the first rasterized image with aliasing to the second rasterized image with anti-aliasing. Further, in one or more embodiments, the series of acts 900 includes generating an additional image pair comprising the first rasterized image and a modified version of the first rasterized image with aliasing or the second rasterized image with anti-aliasing by downsampling the first rasterized image or the second rasterized image and upsampling the first rasterized image or the second rasterized image, applying a blur filter to the first rasterized image or the second rasterized image, modifying a color property of the first rasterized image or the second rasterized image, or applying a compression model to the first rasterized image or the second rasterized image. Moreover, in one or more embodiments, the series of acts 900 includes adjusting the parameters of the image super-resolution model to reduce an output of a loss function determined by comparing the first rasterized image and the modified version of the first rasterized image or the second rasterized image. Further, in one or more embodiments, the series of acts 900 includes generating the upscaled segmentation corresponding to the low-frequency portions of the digital image by generating a segmentation for the low-frequency portions and upscaling the segmentation of the low frequency portions to the second resolution.

Moreover, in one or more embodiments, the series of acts 900 includes selecting the set of image patches based on the high-frequency portions satisfying a density threshold. Additionally, in one or more embodiments, the series of acts 900 includes generating, utilizing a segmentation model, a segmentation of the high-frequency portions from the first upscaled image patches. Moreover, in one or more embodiments, series of acts 900 includes generating the segmentation map by combining the segmentation of the high frequency portions with the upscaled segmentation corresponding to the low-frequency portions.

For example, in one or more embodiments, the series of acts 900 includes selecting a first set of image patches corresponding to high-frequency portions of the digital image. In addition, in one or more embodiments, the series of acts 900 includes generating, utilizing the image super-resolution model, upscaled image patches for the first set of image patches corresponding to the high-frequency portions to a second resolution higher than the first resolution according to an upscaling factor of at least two. Further, in one or more embodiments, the series of acts 900 includes generating an upscaled segmentation for a second set of image patches corresponding to low-frequency portions of the digital image by upscaling a segmentation of the second set of image patches according to the upscaling factor. Further, in some embodiments, the series of acts 900 includes determining a segmentation map for the digital image based on the upscaled image patches and the upscaled segmentation. Moreover, in some embodiments, the series of acts 900 includes generating a vectorized digital image for the digital image according to the segmentation map.

Furthermore, in one or more embodiments, the series of acts 900 includes generating, utilizing an edge detection model, an edge map that indicates the high-frequency portions and the low-frequency portions of the digital image based on detected edges in the edge map. Moreover, in one or more embodiments, the series of acts 900 includes selecting the first set of image patches corresponding the high-frequency portions based on the detected edges in the edge map satisfying a density threshold.

Moreover, in one or more embodiments, the series of acts 900 includes selecting the first set of image patches by utilizing a patch selection model that minimizes, for a predetermined image patch size, a number of image patches corresponding to the high-frequency portions of the digital image. Further, in one or more embodiments, the series of acts 900 includes generating a training dataset by determining, for a vector image, an image pair comprising a first rasterized image with aliasing and a second rasterized image with anti-aliasing.

Moreover, in one or more embodiments, the series of acts 900 includes adjusting parameters of the image super-resolution model to reduce an output of a loss function determined by comparing the first rasterized image with aliasing to the second rasterized image with anti-aliasing to determine a loss. Further, in one or more embodiments, the series of acts 900 includes determining the loss function further based on an additional image pair comprising the first rasterized image with aliasing and a modified version of the first rasterized image with aliasing or the second rasterized image with anti-aliasing by downsampling the first rasterized image or the second rasterized image from the first resolution of the digital image to a third resolution lower than the first resolution and upsampling the first rasterized image or the second rasterized image from the third resolution to the first resolution.

Moreover, in some embodiments, the series of acts 900 includes applying one or more blur filters to the first rasterized image. Further, in some embodiments, the series of acts 900 includes modifying one or more color properties of the first rasterized image. Moreover, in some embodiments, the series of acts 900 includes applying one or more compression models to the first rasterized image.

Furthermore, in one or more embodiments, the series of acts 900 includes generating, utilizing a segmentation model, a segmentation of the high frequency portions from the first upscaled image patches. Moreover, in one or more embodiments, the series of acts 900 includes generating the segmentation map by combining the segmentation of the high frequency portions with the upscaled segmentation for the second set of image patches.

For example, in one or more embodiments, the series of acts 900 includes generating, utilizing an edge detection model on a digital image at a first resolution, an edge map comprising indications of high-frequency portions and low-frequency portions of the digital image. In addition, in one or more embodiments, the series of acts 900 includes generating, utilizing an image super-resolution model, upscaled image patches for a first set of image patches corresponding to the high-frequency portions of the digital image to a second resolution higher than the first resolution according to an upscaling factor of at least two. Further, in one or more embodiments, the series of acts 900 includes generating an upscaled segmentation for a second set of image patches corresponding to the low-frequency portions of the digital image by upscaling a segmentation of the second set of image patches according to the upscaling factor. Further, in some embodiments, the series of acts 900 includes determining a segmentation map for the digital image based on a combination of the upscaled image patches and the upscaled segmentation. Moreover, in some embodiments, the series of acts 900 includes generating a vectorized digital image for the digital image according to the segmentation map.

Furthermore, in one or more embodiments, the series of acts 900 includes minimizing a number of image patches including high-frequency data corresponding to the high-frequency portions and the low-frequency portions of the digital image based on detected edges in the edge map. Moreover, in one or more embodiments, the series of acts 900 includes identifying the second set of image patches based on the second set of image patches failing to satisfy a density threshold indicated by the edge map to further generate the upscaled segmentation for the second set of image patches. Further, in one or more embodiments, the series of acts 900 includes generating, utilizing a segmentation model, a segmentation of the high frequency portions from the upscaled image patches. Further, in some embodiments, the series of acts 900 includes combining the segmentation of the high frequency portions with the upscaled segmentation for the second set of image patches.

Furthermore, in one or more embodiments, the series of acts 900 includes determining, for a vector image, an image pair comprising a first rasterized image with aliasing and a second rasterized image with anti-aliasing. Moreover, in one or more embodiments, the series of acts 900 includes adjusting the parameters of the image super-resolution model to reduce an output of a loss function determined by comparing the first rasterized image with aliasing with the second rasterized image with anti-aliasing to determine a loss.

Further, in one or more embodiments, the series of acts 900 includes generating, for a vector image, an image pair comprising a first rasterized image with aliasing and a modified version of the first rasterized image with aliasing or a second rasterized image with anti-aliasing by downsampling the first rasterized image or the second rasterized image from the first resolution of the digital image to a third resolution lower than the first resolution and upsampling the first rasterized image or the second rasterized image from the third resolution to the first resolution. Moreover, in one or more embodiments, the series of acts 900 includes applying one or more blur filters to the first rasterized image or the second rasterized image. Further, in one or more embodiments, the series of acts 900 includes modifying one or more color properties of the first rasterized image or the second rasterized image. Moreover, in one or more embodiments, the series of acts 900 includes applying one or more compression models to the first rasterized image or the second rasterized image. Further, in one or more embodiments, the series of acts 900 includes adjusting parameters of the image super-resolution model to reduce an output of a loss function determined by comparing the first rasterized image with the modified version of the first rasterized image or the second rasterized image.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 10 illustrates a block diagram of an example computing device 1000 that may be configured to perform one or more of the processes described above. One will appreciate that one or more computing devices, such as the computing device 1000 may represent the computing devices described above (e.g., the server(s) 104 and/or the client device 116). In one or more embodiments, the computing device 1000 may be a mobile device (e.g., a mobile telephone, a smartphone, a PDA, a tablet, a laptop, a camera, a tracker, a watch, a wearable device). In some embodiments, the computing device 1000 may be a non-mobile device (e.g., a desktop computer or another type of client device). Further, the computing device 1000 may be a server device that includes cloud-based processing and storage capabilities.

As shown in FIG. 10, the computing device 1000 can include one or more processor(s) 1002, memory 1004, a storage device 1006, input/output interfaces 1008 (or “I/O interfaces 1008”), and a communication interface 1010, which may be communicatively coupled by way of a communication infrastructure (e.g., bus 1012). While the computing device 1000 is shown in FIG. 10, the components illustrated in FIG. 10 are not intended to be limiting. Additional or alternative components may be used in other embodiments. Furthermore, in certain embodiments, the computing device 1000 includes fewer components than those shown in FIG. 10. Components of the computing device 1000 shown in FIG. 10 will now be described in additional detail.

In particular embodiments, the processor(s) 1002 include hardware for executing instructions, such as those making up a computer program. As an example, and not by way of limitation, to execute instructions, the processor(s) 1002 may retrieve (or fetch) the instructions from an internal register, an internal cache, memory 1004, or a storage device 1006 and decode and execute them.

The computing device 1000 includes memory 1004, which is coupled to the processor(s) 1002. The memory 1004 may be used for storing data, metadata, and programs for execution by the processor(s). The memory 1004 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1004 may be internal or distributed memory.

The computing device 1000 includes a storage device 1006 including storage for storing data or instructions. As an example, and not by way of limitation, the storage device 1006 can include a non-transitory storage medium described above. The storage device 1006 may include a hard disk drive (HDD), flash memory, a Universal Serial Bus (USB) drive or a combination these or other storage devices.

As shown, the computing device 1000 includes one or more I/O interfaces 1008, which are provided to allow a user to provide input to (such as user strokes), receive output from, and otherwise transfer data to and from the computing device 1000. These I/O interfaces 1008 may include a mouse, keypad or a keyboard, a touch screen, camera, optical scanner, network interface, modem, other known I/O devices or a combination of such I/O interfaces 1008. The touch screen may be activated with a stylus or a finger.

The I/O interfaces 1008 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1008 are configured to provide graphical data to a display for presentation to a user. The graphical data may be representative of one or more graphical user interfaces and/or any other graphical content as may serve a particular implementation.

The computing device 1000 can further include a communication interface 1010. The communication interface 1010 can include hardware, software, or both. The communication interface 1010 provides one or more interfaces for communication (such as, for example, packet-based communication) between the computing device and one or more other computing devices or one or more networks. As an example, and not by way of limitation, communication interface 1010 may include a network interface controller (NIC) or network adapter for communicating with an Ethernet or other wire-based network or a wireless NIC (WNIC) or wireless adapter for communicating with a wireless network, such as a WI-FI. The computing device 1000 can further include a bus 1012. The bus 1012 can include hardware, software, or both that connects components of computing device 1000 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed:

1. A computer-implemented method comprising:
selecting, by at least one processor, a set of image patches corresponding to high-frequency portions of a digital image at a first resolution;
generating, by the at least one processor utilizing an image super-resolution model, upscaled image patches for the set of image patches corresponding to the high-frequency portions to a second resolution higher than the first resolution according to an upscaling factor of at least two;
generating, by the at least one processor, a segmentation map for the digital image based on the upscaled image patches and an upscaled segmentation corresponding to low-frequency portions of the digital image; and
generating, by the at least one processor, a vectorized digital image for the digital image according to the segmentation map.

2. The computer-implemented method of claim 1, wherein selecting the set of image patches further comprises:
generating, utilizing an edge detection model, an edge map that indicates the high-frequency portions and the low-frequency portions of the digital image based on detected edges in the edge map; and
selecting the set of image patches from the digital image according to the high-frequency portions indicated by the edge map.

3. The computer-implemented method of claim 2, wherein selecting the set of image patches comprises determining, using the edge map, the set of image patches that minimizes a number of image patches in the set of image patches corresponding to the high-frequency portions for a predetermined image patch size.

4. The computer-implemented method of claim 1, further comprising:
generating a training dataset by determining, for a vector image, an image pair comprising a first rasterized image with aliasing and a second rasterized image with anti-aliasing; and
adjusting parameters of the image super-resolution model based on the first rasterized image and the second rasterized image.

5. The computer-implemented method of claim 4, wherein adjusting the parameters of the image super-resolution model comprises adjusting the parameters of the image super-resolution model to reduce an output of a loss function determined by comparing the first rasterized image with aliasing to the second rasterized image with anti-aliasing.

6. The computer-implemented method of claim 4, further comprising:
generating an additional image pair comprising the first rasterized image and a modified version of the first rasterized image with aliasing or the second rasterized image with anti-aliasing by downsampling the first rasterized image or the second rasterized image and upsampling the first rasterized image or the second rasterized image, applying a blur filter to the first rasterized image, modifying a color property of the first rasterized image, or applying a compression model to the first rasterized image; and
adjusting the parameters of the image super-resolution model to reduce an output of a loss function determined by comparing the first rasterized image and the modified version of the first rasterized image or the second rasterized image.

7. The computer-implemented method of claim 1, further comprising generating the upscaled segmentation corresponding to the low-frequency portions of the digital image by generating a segmentation for the low-frequency portions and upscaling the segmentation of the low-frequency portions to the second resolution.

8. The computer-implemented method of claim 1, wherein selecting the set of image patches corresponding to the high-frequency portions comprises selecting the set of image patches based on the high-frequency portions satisfying a density threshold.

9. The computer-implemented method of claim 1, wherein generating the segmentation map comprises:
generating, utilizing a segmentation model, a segmentation of the high-frequency portions from the upscaled image patches; and
generating the segmentation map by combining the segmentation of the high-frequency portions with the upscaled segmentation corresponding to the low-frequency portions.

10. A system comprising:
one or more memory devices comprising a digital image at first resolution and an image super-resolution model; and
one or more processors configured to cause the system to:
select a first set of image patches corresponding to high-frequency portions of the digital image;
generate, utilizing the image super-resolution model, upscaled image patches for the first set of image patches corresponding to the high-frequency portions to a second resolution higher than the first resolution according to an upscaling factor of at least two;
generate an upscaled segmentation for a second set of image patches corresponding to low-frequency portions of the digital image by upscaling a segmentation of the second set of image patches according to the upscaling factor;
determine a segmentation map for the digital image based on the upscaled image patches and the upscaled segmentation; and
generate a vectorized digital image for the digital image according to the segmentation map.

11. The system of claim 10, wherein the one or more processors are configured to cause the system to:
generate, utilizing an edge detection model, an edge map that indicates the high-frequency portions and the low-frequency portions of the digital image based on detected edges in the edge map; and
select the first set of image patches corresponding the high-frequency portions based on the detected edges in the edge map satisfying a density threshold.

12. The system of claim 10, wherein the one or more processors are configured to cause the system to select the first set of image patches by utilizing a patch selection model that minimizes, for a predetermined image patch size, a number of image patches corresponding to the high-frequency portions of the digital image.

13. The system of claim 10, wherein the one or more processors are configured to cause the system to:
generate a training dataset by determining, for a vector image, an image pair comprising a first rasterized image with aliasing and a second rasterized image with anti-aliasing; and
adjust parameters of the image super-resolution model to reduce an output of a loss function determined by comparing the first rasterized image with aliasing to the second rasterized image with anti-aliasing to determine a loss.

14. The system of claim 13, wherein the one or more processors are configured to cause the system to determine the loss function further based on an additional image pair comprising the first rasterized image with aliasing and a modified version of the first rasterized image with aliasing or the second rasterized image with anti-aliasing by:
downsampling the first rasterized image or the second rasterized image from the first resolution of the digital image to a third resolution lower than the first resolution and upsampling the first rasterized image or the second rasterized image from the third resolution to the first resolution;
applying one or more blur filters to the first rasterized image or the second rasterized image;
modifying one or more color properties of the first rasterized image or the second rasterized image; or
applying one or more compression models to the first rasterized image or the second rasterized image.

15. The system of claim 10, wherein the one or more processors are configured to cause the system to determine the segmentation map for the digital image by:
generate, utilizing a segmentation model, a segmentation of the high-frequency portions from the upscaled image patches; and
generate the segmentation map by combining the segmentation of the high-frequency portions with the upscaled segmentation for the second set of image patches.

16. A non-transitory computer-readable medium storing executable instructions which, when executed by at least one processing device, cause the at least one processing device to perform operations comprising:
generating, utilizing an edge detection model on a digital image at a first resolution, an edge map comprising indications of high-frequency portions and low-frequency portions of the digital image;
generating, utilizing an image super-resolution model, upscaled image patches for a first set of image patches corresponding to the high-frequency portions of the digital image to a second resolution higher than the first resolution according to an upscaling factor of at least two;
generating an upscaled segmentation for a second set of image patches corresponding to the low-frequency portions of the digital image by upscaling a segmentation of the second set of image patches according to the upscaling factor;
determining a segmentation map for the digital image based on a combination of the upscaled image patches and the upscaled segmentation; and
generating a vectorized digital image for the digital image according to the segmentation map.

17. The non-transitory computer-readable medium of claim 16, wherein selecting the first set of image patches comprises minimizing a number of image patches including high-frequency data corresponding to the high-frequency portions and the low-frequency portions of the digital image based on detected edges in the edge map.

18. The non-transitory computer-readable medium of claim 16, wherein generating the segmentation map comprises:
identifying the second set of image patches based on the second set of image patches failing to satisfy a density threshold indicated by the edge map to further generate the upscaled segmentation for the second set of image patches;
generating, utilizing a segmentation model, a segmentation of the high-frequency portions from the upscaled image patches; and
combining the segmentation of the high-frequency portions with the upscaled segmentation for the second set of image patches.

19. The non-transitory computer-readable medium of claim 16, wherein the operations further comprise adjusting parameters of the image super-resolution model utilizing a training dataset by:
determining, for a vector image, an image pair comprising a first rasterized image with aliasing and a second rasterized image with anti-aliasing; and
adjusting the parameters of the image super-resolution model to reduce an output of a loss function determined by comparing the first rasterized image with aliasing with the second rasterized image with anti-aliasing to determine a loss.

20. The non-transitory computer-readable medium of claim 16, wherein the operations further comprise:
generating, for a vector image, an image pair comprising a first rasterized image with aliasing and a modified version of the first rasterized image with aliasing or a second rasterized image with anti-aliasing by:
downsampling the first rasterized image or the second rasterized image from the first resolution of the digital image to a third resolution lower than the first resolution and upsampling the first rasterized image or the second rasterized image from the third resolution to the first resolution;
applying one or more blur filters to the first rasterized image or the second rasterized image;
modifying one or more color properties of the first rasterized image or the second rasterized image; or
applying one or more compression models to the first rasterized image or the second rasterized image; and
adjusting parameters of the image super-resolution model to reduce an output of a loss function determined by comparing the first rasterized image with the modified version of the first rasterized image or the second rasterized image.
